(19) United States
(12) Patent Application Publication
(10) Pub. No.: US 2022/0299973 A1
(43) Pub. Date: Sep. 22, 2022

(54) MANUFACTURING SYSTEM THROUGHPUT BOTTLENECK INDICATOR ANALYSIS

(71) Applicant: GM GLOBAL TECHNOLOGY OPERATIONS LLC, Detroit, MI (US)

(72) Inventor: Douglas J. Harris, Oxford, MI (US)

(73) Assignee: GM GLOBAL TECHNOLOGY OPERATIONS LLC, Detroit, MI (US)

(21) Appl. No.: 17/206,688

(22) Filed: Mar. 19, 2021

(51) Int. Cl. G05B 19/4097

(52) U.S. Cl. CPC G05B 19/4097; G05B 2219/32088

(57) ABSTRACT

A method identifies bottlenecks in a manufacturing system. The method includes: creating a flow diagram showing how parts travel through the manufacturing system, wherein the manufacturing system comprises stations and buffers; identifying work zones in the flow diagram that will be analyzed; identifying predecessors and successors for each of the work zones in the flow diagram; receiving a buffer use and station block/starve data of the manufacturing system; gathering the buffer use and station block/starve data for the predecessors and the successors previously identified by the controller; calculating a block ratio (BR) of the predecessors and the successors previously identified by the controller; calculating bottleneck indicator (BI) values for the work zones using the BR of the predecessors and the successors; making a list of the BI values from the highest to the lowest to identify a top bottleneck work zone of the work zones.

### INTRODUCTION

The present disclosure generally relates to manufacturing and, more particularly, a manufacturing system throughput bottleneck indicator analysis.

While in a manufacturing environment, buffer utilization and station block/starve states may be monitored as an indicator for where bottlenecks exist, there is a need to analytically quantify the bottleneck impact of a work zone to maximize the throughput of a manufacturing system.

In the present disclosure, a method is used to analytically identify the top bottleneck work zone of a manufacturing system. By doing so, the manufacturing system can be controlled to address the top bottleneck work zone, thereby maximizing throughput. This analytical method allows bottleneck identification with both simulation output and plant floor data with immediate results. Accordingly, this method does not necessarily require a simulation analysis.

In an aspect of the present disclosure, a method for identifying bottlenecks in a manufacturing system includes: creating, by a controller, a flow diagram showing how parts travel through the manufacturing system, wherein the manufacturing system comprises stations and buffers; identifying, by the controller, work zones in the flow diagram that will be analyzed; identifying, by the controller, predecessors and successors for each of the work zones in the flow diagram, wherein each of the predecessors and the successors is at least one of the stations or the buffers of the manufacturing system; receiving, by the controller, a buffer use and station block/starve data of the manufacturing system; gathering, by the controller, the buffer use and station block/starve data for the predecessors and the successors previously identified by the controller; calculating, by the controller, a block ratio (BR) of the predecessors and the successors previously identified by the controller; calculating, by the controller, bottleneck indicator (BI) values for the work zones using the BR of the predecessors and the successors; making a list, by the controller, of the BI values from the highest to the lowest to identify a top bottleneck work zone of the work zones, wherein the top bottleneck work zone has a highest value of the BI values; and controlling the manufacturing system taking into account the top bottleneck work zone to maximize throughput of the manufacturing system.

In an aspect of the present disclosure, the work zones include an intermediate work zone. The predecessor includes a single predecessor of the intermediate work zone. The successors include a single successors of the intermediate work zone such that the intermediate work zone has the single predecessor immediately preceding the intermediate work zone and the single successor immediately succeeding the intermediate work zone. Calculating, by the controller, the BI values for the work zones using the BR of the predecessors and the successors includes calculating the BI value of the intermediate work zone using a following equation:

BI=BR_{pred}−BR_{succ}
where:
BI is the BI value of the intermediate work zone;
BR_{pred} is the BR of the single predecessor of the intermediate work zone; and
BR_{succ} is the BR of the single successor of the intermediate work zone.

In an aspect of the present disclosure, the work zones include an assembly work zone. The predecessors include predecessors immediately preceding the assembly work zone. The successors include a single successor immediately succeeding the assembly work zone such that the assembly work zone has the predecessors and the single successor.

In an aspect of the present disclosure, calculating, by the controller, the BI values for the work zones using the BR of the predecessors and the successors includes calculating the BI value of the assembly work zone using a following equation:

BI=Min(BR_{pred})−BR_{succ}
where:
BI is the BI value of the assembly work zone;
Min(BR_{pred}) is the BR of one of the predecessors with a lowest value; and
BR_{succ} is the BR of the single successor of the assembly work zone.

In an aspect of the present disclosure, the work zones include a disassembly work zone. The predecessors include a single predecessor immediately preceding the disassembly work zone. The sucessors include successors immediately succeeding the disassembly work zone such that disassembly work zones have the single predecessor and successors.

In an aspect of the present disclosure, calculating, by the controller, the BI values for the work zones using the BR of the predecessors and the successors includes calculating the BI value of the disassembly work zone using a following equation:

BI=BR_{pred}−Max(BR_{succ});
where:
BI is the BI value of the disassembly work zone;
BR_{pred} is the BR of the single predecessor; and
Max(BR_{succ}) is the BR of one of the predecessors with a highest value.

In an aspect of the present disclosure, the work zones include a merge work zone. Calculating, by the controller, the BI values for the merge work zone using the BR of the predecessors and the successors includes calculating the BI value of the merge work zone using a following equation:

BI=PartCntWtdAvg(BR_{pred})−BR_{succ};
where:
BI is the BI value of the merge work zone;
PartCntWtdAvg(BR_{pred}, is a part count weighted average of the predecessors immediately preceding the merge work zone; and
BR_{succ} is the BR of the single successor of the work zone.

In an aspect of the present disclosure, the work zones include a split work zone. Calculating, by the controller, the BI values for the split work zone using the BR of the predecessors and the successors includes calculating the BI value of the split work zone using a following equation:

BI=BR_{pred}−PartCntWtdAvg(BR_{succ});
where:
BI is the BI value of the merge work zone;
BR_{pred} is the BR of the single predecessor of the intermediate work zone; and
PartCntWtdAvg(BR_{succ}) is a part count weighted average of the successors immediately succeeding the split work zone.

The BI of the work zones may be evaluated using any combination of the predecessors and successors BR evaluations. That is, the BI can be evaluated in all the forms below:

BI=BR_{pred}−BR_{succ}

BI=BR_{pred}−Max(BR_{succ})

BI=BR_{pred}−PartCntWtdAvg(BR_{succ})

BI=Min(BR_{pred})−BR_{succ}

BI=Min(BR_{pred})−Max(BR_{succ})

BI=Min(BR_{pred})−PartCntWtdAvg(BR_{succ})

BI=PartCntWtdAvg(BR_{pred})−BR_{succ}

BI=PartCntWtdAvg(BR_{pred})−Max(BR_{succ})

BI=PartCntWtdAvg(BR_{pred})−PartCntWtdAvg(BR_{succ})

In the list above, this would be:
Single in—Single out
Single in—Disassembly out
Single in—Split out
Assembly in—Single out
Assembly in—Disassembly out
Assembly In—Split out
Merge In—Single out
Merge in—Disassemble out
Merge in—Split out.

In an aspect of the present disclosure, calculating, by the controller, the BR of the predecessors and the successors previously identified by the controller includes calculating the BR of the buffers using a following equation:

BR=(BufferFullRatio\hat{ }(Exp Factor)×0.5)−(1−BufferFullRatio)\hat{ }(Exp Factor)×0.5);
where:
BR is the block ratio of the buffers;
BufferFullRatio is a buffer full ratio; and
Exp Factor is an exponential factor;
wherein a buffer full ratio is calculated using a following equation:

BufferFullRatio=(AveragePartCount−Minimum Threshold)/(Maximum Threshold−Minimum Threshold);
where:
AveragePartCount is an average number of parts observed in the buffer for the time of observation;

Minimum Threshold is a minimum threshold of jobs that the buffers must have to prevent a downstream system from starvation; and

Maximum Threshold is a maximum number of jobs that are able to be stored in the buffers before upstream blocking occurs.

In an aspect of the present disclosure, calculating the BR of the buffers includes calculating the exponential factor using a following formula:

Exp Factor=(0.007×(Max Threshold−Min Threshold)\hat{ }(Flatness)−(0.017×(Max Threshold−Min Threshold)+3.3;
where:
Exp Factor is the exponential factor;
Min Threshold is a minimum threshold of jobs that the buffers have to prevent starvation downstream;
Max Threshold is a maximum number of jobs that the buffers is able to store blocking occurs upstream; and
Flatness is equal to 2.

In an aspect of the present disclosure, calculating, by the controller, the BR of the predecessors and the successors previously identified by the controller includes calculating the BR of the stations using a following equation:

BR=Block %/(Block %+Starve %),
where:
Block % is the percentage of time that the station is blocked in the time of observation, and Starve % is the percentage of time the station is starved in the time of observation. where:

In an aspect of the present disclosure, calculating, by the controller, the BR of the predecessors and the successors previously identified by the controller includes calculating the BR of the predecessor that is at the beginning of the flow diagram using a following equation:

BR_{pred}=0.5+0.5*(Block %),
where:
BR_{pred} is the BR of the predecessor that is at the beginning of the flow diagram; and
Block % is the percentage of time that the predecessor at the beginning of the flow diagram is blocked in a predetermined time of observation.

In an aspect of the present disclosure, calculating, by the controller, the BR of the predecessors and the successors previously identified by the controller includes calculating the BR of the successor that is at an end of the flow diagram using a following equation:

BR_{succ}=0.5*(1−Starve %);
where:
BR_{succ} is the BR of the successor that is at the end of the flow diagram; and
Starve % is the percentage of time the successor at the end of the flow diagram is starved in a predetermined time of observation.

In an aspect of the present disclosure, the predecessors include a subject predecessor and a plurality of subject successors immediately preceding the subject predecessor. Calculating, by the controller, the BR of the predecessor previously identified by the controller includes calculating the BR of the subject predecessor using a following equation:

BR_{pred}=BR_{pred}−(BR_{pred}+1)*(Starve %−Starve %_{MinPredSucc})/(Starve %_{MaxPredSucc}−Starve %_{MinPredSucc});
where:
BR_{pred} is the block ratio of the subject predecessor;
BR_{MinPredSucc} is the minimum block ratio of the plurality of subject predecessor successors; and
BR_{MaxPredSucc} is the maximum block ratio of the plurality of subject predecessor successors.

In an aspect of the present disclosure, wherein the successors include a subject successor and a plurality of subject predecessors immediately preceding the subject successor. Calculating, by the controller, the BR of the successor previously identified by the controller includes calculating the BR of the subject successors using a following equation:

BR_{succ}=BR_{succ}−(1−BR_{succ})*(Block %−Block %_{MinSuccPred})/(Block %_{MaxSuccPred}−Block %_{MinSuccPred});
where:
BR_{succ} is the block ratio of subject successor;
BR_{MinSuccPred} is the minimum block ratio of the plurality of subject successor predecessors; and
BR_{MaxSuccPred} is the minimum block ratio of the plurality of subject successor predecessors.

In an aspect of the present disclosure, the predecessor may include a subject predecessor of a work zone with no predecessor itself because it is at the beginning of the flow diagram, and calculating, by the controller, the BR of that predecessor previously identified by the controller includes calculating the BR of the subject predecessor using the following formula:

BR_{pred}=1−BR_{succ};

where:
BR_{pred} is the BR of the subject predecessor; and
BR_{succ} is the BR of the successor.

In an aspect of the present disclosure, the successors may include a subject successor of a work zone with no successor itself because it is at the end of the flow diagram, and calculating, by the controller, the BR of that successor previously identified by the controller is done using the following formula:

BR_{succ}=1−BR_{pred}

where:
BR_{succ} is the BR of the subject successor; and
B_{pred} is the of the predecessor.

The present disclosure also describes a control system. In an aspect of the present disclosure, the control system includes a controller configured to be in communication with a manufacturing system. The controller is programmed to: create a flow diagram showing how parts travel through the manufacturing system, wherein the manufacturing system comprises stations and buffers; identify work zones in the flow diagram that will be analyzed; identify predecessors and successors for each of the work zones in the flow diagram, wherein each of the predecessors and the successors is the stations or the buffers of the manufacturing system; receive buffer use and station block/starve data of the manufacturing system; gather the buffer use and station block/starve data for the predecessors and the successors previously identified by the controller; calculate a block ratio (BR) of the predecessors and the successors previously identified by the controller; calculate bottleneck indicator (BI) values for the work zones using the BR of the predecessors and the successors; make a list of the BI values from the highest to the lowest to identify a top bottleneck work zone of the work zones, wherein the bottleneck work zone has a highest value of the BI values; and control the manufacturing system taking into account the top bottleneck work zone to maximize throughput of the manufacturing system.

The above features and advantages and other features and advantages of the present teachings are readily apparent from the following detailed description of the modes for carrying out the present teachings when taken in connection with the accompanying drawings.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1. is schematic front view of a manufacturing system.

FIG. 2 is a flowchart of a method for identifying bottlenecks in a manufacturing system.

FIG. 3 is a flow diagram of the manufacturing system of FIG. 1.

### DETAILED DESCRIPTION

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

The following detailed description is merely exemplary in nature and is not intended to limit the application and uses. Furthermore, there is no intention to be bound by expressed or implied theory presented in the preceding technical field, background, brief summary or the following detailed description. As used herein, the term “module” refers to hardware, software, firmware, electronic control component, processing logic, and/or processor device, individually or in a combination thereof, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by a number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with a number of systems, and that the systems described herein are merely exemplary embodiments of the present disclosure.

For the sake of brevity, techniques related to signal processing, data fusion, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that alternative or additional functional relationships or physical connections may be present in an embodiment of the present disclosure.

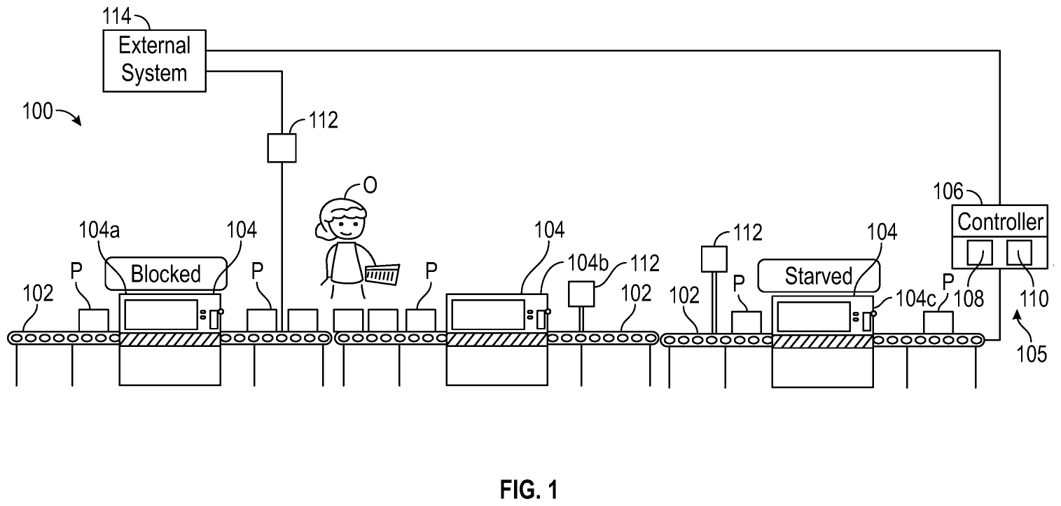

With reference to FIG. 1, a manufacturing system 100 is configured to assemble parts P together. An operator O may operate or at least monitor the manufacturing system 100. In the depicted embodiment, the manufacturing system 100 includes one or more conveyor belts 102 for moving parts and one or more workstations 104 for performing work on those parts P. While using the manufacturing system 100, some workstations 104 may cause a bottleneck (see workstations 104b), causing other workstations 104 to be either blocked (see workstation 104a) or starved (see workstation 104c). It is therefore desirable to identify throughput bottlenecks in the manufacturing system 100. In the present disclosure, buffer utilization and station block/starve data are utilized to identify throughput bottlenecks in the manufacturing system 100.

The manufacturing system 100 may include or be connected to a controller 106 to aid in the identification of throughput bottlenecks. The controller 106 is part of a control system 105 and includes at least one processor 108 and a non-transitory computer readable storage device or media 110. The processor 108 may be a custom made processor, a central processing unit (CPU), an auxiliary processor among several processors associated with the controller 106, a semiconductor-based microprocessor (in the form of a microchip or chip set), a macroprocessor, a combination thereof, or generally a device for executing instructions. The computer readable storage device or media 110 may include volatile and nonvolatile storage in read-only memory (ROM), random-access memory (RAM), and keep-alive memory (KAM), for example. KAM is a persistent or non-volatile memory that may be used to store various operating variables while the processor 108 is powered down. The computer-readable storage device or media 110 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 106 in controlling the manufacturing system 100.

The manufacturing system 100 may include one or more sensors 112, such as laser sensors, to detect buffer use data and/or station block/starve data. The sensors 112 may be in communication with an external system 114 and/or the controller 106. The external system 112 may include a processor and may be in communication with the controller 106.

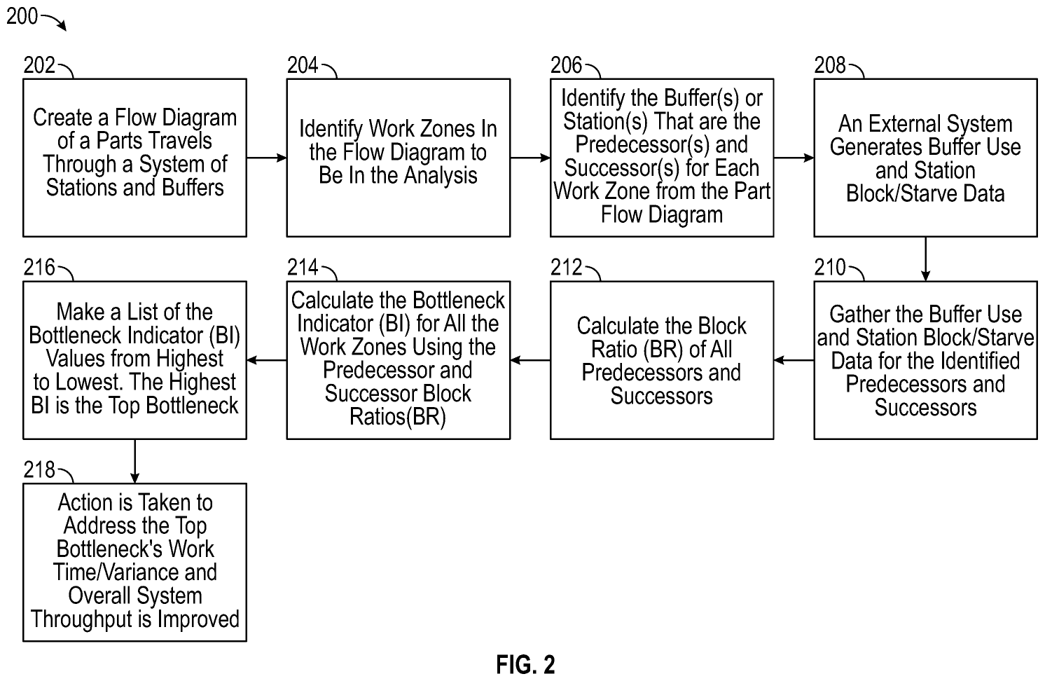

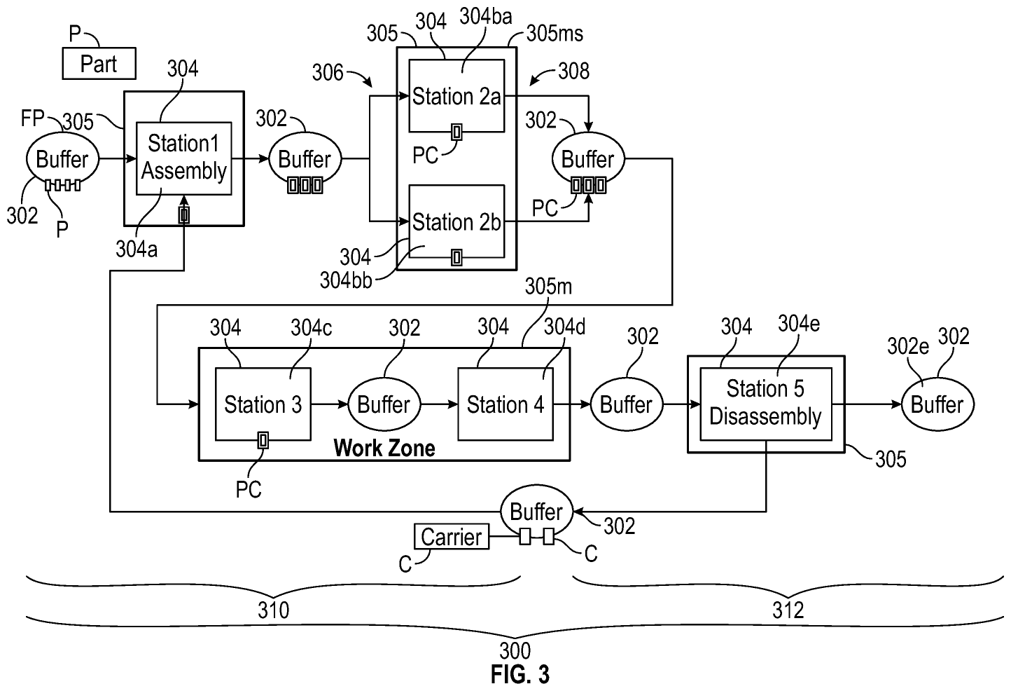

FIG. 2 is a flowchart of a method 200 for identifying bottlenecks in the manufacturing system 100 (FIG. 1) using buffer utilization data and station block/starve data. The method 200 begins at block 202. At block 202, the controller 106 creates a flow diagram 300 (FIG. 3) showing how parts P (FIG. 1) travel through the manufacturing system 100.

FIG. 3 is a schematic flow diagram 300 created at block 202 of the method 200 (FIG. 2). This flow diagram 300 may be created using the data stored on the non-transitory computer readable storage device or media 110 of the controller 106 (FIG. 1). In the depicted embodiment, the parts P flow through a specific arrangements of buffers 302 and stations 304 of the manufacturing system 100. However, it is envisioned that the manufacturing system 100 may have a different arrangement. In the present disclosure, the term “part” means the object that flows through the manufacturing system 100, which includes buffers 302 and stations 304. Therefore, the flow diagram 300 is a system diagram of the part flow through the buffers 302 and the stations 304 and therefore shows how the parts P travel through the buffers 302 and stations 304 of the manufacturing system 100. In the present disclosure, the term “buffer” means a location (in the manufacturing system 100) that stores parts between stations 304 and no work is performed. Travel time may lapse while the part P travels through the buffer 302. In the present disclosure, the term “station” means a location (in the manufacturing system 100) where work is performed on a part P or multiple parts P concurrently. The work takes time and that time may have a variance. The term “work zone” means a single station or a subset of the flow (which includes stations and buffers).

In the flow diagram 300, a first station 304a performs work on a part P on a carrier C (i.e., part on a carrier PC). Specifically, the first station 304a may assemble one or more parts P. Thus, the work performed at the first station 304a may be considered assembly. In the present disclosure, the term “assembly” means a situation when parts P or a part and a carrier C are taken from multiple predecessors and becomes one. Accordingly, the term “assembly work zone” means a work zone where parts P or a part and a carrier C are taken from multiple predecessors and become one. Alternatively, the term “assembly” means a situation when a part P or a part P are taken from multiple predecessors and become one. Accordingly, the term “assembly work zone” means a work zone where parts P or a part and a carrier C are taken from multiple predecessors and becomes one. The first station 304a may be referred as the assembly work zone and is preceded by one or more buffers 302. The buffer 302 at the beginning of the flow diagram 300 may be referred to as the first buffer or the first predecessor FP. Therefore, one of the buffers 302 is a predecessor to the first station 304a. In the present disclosure, the term “predecessor” means the station(s) 304 and/or buffer(s) 302 that are before a work zone 305 in the flow diagram 300. The first station 304a is considered a work zone 305. In the present disclosure, the term “work zone” means a single station or a subset of the flow (which may include stations and buffers). Further, the first station 304a may be succeeded by another buffer 302. This buffer 302 may therefore be a successor to the first station 304a. In the present disclosure, the term “successor” means the station(s) 304 and buffer(s) 302 that are after a work zone 305 in the flow diagram 300. In the depicted embodiment, there is a split 306 after this buffer 302. In the present disclosure, the term “split” means a situation when the part is sent to one of multiple successors. After the split 306, the part P proceeds to second stations 304ba and 304bb. The second stations 304ba and 304bb may together form a parallel work zone 305ms. After work is performed on the parts P at the second stations 304ba and 304bb, the parts P are merged at merge 308. In the present disclosure, the term “merge” means a situation when a part is taken from one of multiple predecessors. After the merge, the part P travels to another buffer 302. The part on the carrier PC may travel through this buffer 302. The buffers 302 and stations 304 described above may be blocked stations and buffers 310. In the present disclosure, the term “block” and its past tense “blocked” describes a situation when a station 304 and a buffer 302 has completed its work or travel, but cannot move forward in the flow to the successor because the successor is full of part(s) P.

After the part P or parts travel through the buffer 302 succeeding the merge 308, the part P or parts P travel through the third station 304c. The third station 304c may be considered a bottleneck. In the present disclosure, the term “bottleneck” means a location where there is a transition of a higher block ratio to a lower block ratio. This highest transition is the number 1 bottleneck. After the third station 304c, the part(s) P then proceed to another buffer 302. After this buffer 302, the part(s) P proceed to a fourth station 304d. The third station 304c, the fourth station 304d, and the buffer 302 between the third station 304c and the fourth station 304d may be considered an intermediate work zone 305m. In the flow diagram 300, there is another buffer 302 after the fourth station 304d. This buffer 302 is a successor to the fourth station 304d and a predecessor of a fifth station 304e. The intermediate work zone 305m may have solely one successor and solely one predecessor. Alternatively, the intermediate work zone 305m may have multiple successors and multiple predecessors.

The fifth station 304e may constitute a work zone 305 and may perform work, which may be considered disassembly. For this reason, the fifth station 304e may be referred to as the disassembly work zone. In the present disclosure, the term “disassembly” means a situation when one part P or a part on a carrier PC is sent as multiple parts P or a part on a carrier PC to multiple successors. Accordingly, the term “disassembly work zone” means a work zone where one part P or a part on a carrier PC is sent as multiple parts P or a part on a carrier PC to multiple successors. Alternatively, the term “disassembly” means a situation where part P is disassembled into multiple parts P and sent to multiple predecessors. Another buffer 302 may be after the fifth station 304e and may therefore be considered a successor of the fifth station 304e. The buffer 302 immediately succeeding the fifth station 304e may be referred to as the last buffer 302e at the end of the flow diagram 300. The buffer 302 preceding the fourth station 304d, the buffer 302 succeeding the fourth station 304d, the fifth station 304e, and the buffer 302 succeeding the fifth station 304d may be considered starved stations and buffers 312. In the present disclosure, the term “starve” or its past tense “starved” means a situation when a station 304 or buffer 302 is available to accept a part P but cannot because the predecessor is empty of part(s) P. There is an additional buffer 302 between the fifth station 304e and the first station 304a. The carriers C may travel from the fifth station 304e back to the first station 304a.

Returning to FIG. 2, after creating the flow diagram 300 (FIG. 3), the method 200 proceeds to block 204. At block 204, the controller 106 identifies work zones 305 in the flow diagram 300 (FIG. 3) to be analyzed. It is contemplated that all the work zones 305 in the flow diagram 300 may be identified as work zones 305 that will be analyzed by the method 300. Alternatively, some of the work zones 305 may be identified as the work zones 305 that will be analyzed. After block 204, the method 200 proceeds to block 206.

At block 206, the controller 106 identifies the stations 304 and the buffers 302 that are predecessor(s) and successor(s) for each work zone 305 in the flow diagram 300 identified at block 204. It is envisioned that the controller 106 may identify the successors and predecessor for all work zones 305 in the flow diagram 300. The method 300 then proceeds to block 208.

At block 208, the external system 114 generates buffer use and station block/starve data based on inputs from the sensors 112 for each. Alternatively, the controller 106 may be indirectly coupled to the sensors 112. As such, the controller 106 generates the buffer use and station block/starve data based on inputs from the sensors 112. The sensors 112 may therefore be connected to each work zone 305 of the manufacturing system 100. Then, the method 300 continues to block 210. The buffer use and station block/starve data may include, for example, the number of parts P in each buffer 302, the part capacity of each buffer 302, the average number of parts P in each buffer 302 in a predetermined period of time, etc. At block 210, the controller 106 gathers the buffer use and station block/starve data for the predecessors and successors identified at block 208. To do so, the external system 114 communicates the buffer use and station block/starve data for the predecessors and successors identified at block 208. Then, the method 300 continues to block 212.

At block 212, the controller 106 calculates the Block Ratio (BR) for all the predecessors and successors identified at block 206. The BR of a buffer 302 may be the average number of parts P in a buffer 302 divided by the part capacity of that buffer 302. However, there are a number of considerations that make the formula more robust. Rather than using the maximum capacity of the buffer 302, a maximum threshold is used to calculate the BR for the buffer 302. Further, rather than using zero (0) as the minimum, a minimum threshold is used to calculate the BR of the buffer 302. Buffers 302 may vary in size and, for this reason, rather than using a linear formula, a scaling methodology flattens out the middle section of the BR. The flattening is less dramatic in smaller buffers 302 and more dramatic in larger buffers 302. Therefore, for buffers 302, the BR equal to ((BufferFullRatio\hat{ }(Exp Factor)×0.5)−(1−BufferFull Ratio)\hat{ }(Exp Factor)×0.5). The BufferFull Ratio is buffer full ratio and is defined by the following formula: BufferFullRatio=(AveragePartCount−Minimum Threshold)/(Maximum Threshold−Minimum Threshold). The AveragePartCount is the average number of parts observed in the buffer for the time of observation. The Minimum Threshold is the minimum threshold of jobs that a buffer must have to prevent the downstream system from starvation. The Maximum Threshold is the maximum number of jobs that can be stored in the buffer before upstream blocking occurs. The Exp Factor is an exponential factor and is equal to (0.007×(Max Threshold−Min Threshold)\hat{ }(Flatness)−(0.017×(Max Threshold−Min Threshold)+3.3. The Flatness is equal to 2.

For stations 304, the BR of a station 304 is equal to Block %/(Block %+Starve %), wherein Block % is the percentage of time that the station 304 is blocked in the time of observation, and Starve % is the percentage of time the station 304 is starved in the time of observation. Since the stations 304 only have a capacity of 1, there is no need to flatten. This formula, however, is not used in the flow diagram 300 because all the work zones 304 are surrounded by buffers 302.

The BR of a predecessor with no predecessor is equal to 0.5+0.5*(Block %), wherein the Block % is the percentage of time that the predecessor is blocked in the time of observation. The BR of a successor with no successor is equal to 0.5*(1−Starve %). This formula is used in the flow diagram 300 for the buffer 302 before the work zone 305 that has the first station 304a. The Starve % is the percentage of time the successor is starved in the time of observation. This formula is used in the flow diagram 300 for the buffer 302 before the work zone 305 that has the last station 304e.

The BR for a predecessor with multiple successors is calculated using the following formula BR_{pred}=BR_{pred}−(BR_{pred}+1)*(Starve %−Starve %_{MinPredSucc}) (Starve %_{MaxPredSucc}−Starve %_{MinPredSucc}), where BR_{pred} is the BR of the predecessor, Starve % is the percentage of time the predecessor is starved in the time of observation, Starve %_{MinPredSucc} is the minimum Starve % of all the predecessor's successors, and Starve %_{MaxPredSucc} is the maximum Starve % of all the predecessor's successor. The BR for a successor with multiple predecessors is calculated using the following formula BR_{succ}=BR_{succ}+(1−BR_{succ})*(Block %−Block %_{MinSuccPred})/(Block %_{MaxSuccPred} Block %_{MinSuccPred}), where BR_{pred} is the block ratio of a predecessor, Block % is the percentage of time that the successor is blocked in the time of observation, Block %_{MaxSuccPred} is the maximum Block % of all the successor's predecessors, and Block %_{MinSuccPred} is the minimum Block % of all the successor's predecessors. In the flow diagram 300, this is equation is not used since the second stations 304ba and 304bb are in a work zone 305. After calculating the BR as explained above, the method 200 proceeds to block 214. In the case of a predecessor with multiple successors or a successor with multiple predecessors, the highest contributors of the Starve % or Block %, respectively, is identified and the BR for the object of concern must be adjusted appropriately. Alternatively, in this formulas, the BR values may be used instead of the Block Starve % values. The Starve % and the Block % are part of the station block/starve data and may be determined using the sensors 112.

At block 214, the controller 106 calculates the bottleneck indicator (BI) value for all the work zones 305 using the BR of the predecessor and the BR of the successor. The BI value is the BR of the predecessor minus the BR of the successor. Accordingly, for a single predecessor and a single successor, the BI value is equal to BR_{pred}−BR_{succ}, wherein BR_{pred} is the block ratio of a predecessor and BR_{succ} is the BR of a successor. For merge of predecessors and split to successors, the BI value is equal to PartCntWtdAvg(BR_{pred}) PartCntWtdAvg(BR_{succ}), wherein PartCntWtdAvg(BR_{pred}) is a part count weighted average of each predecessor and PartCntWtdAvg(BR_{succ}) is a part count weighted average of each successor. For assembly of predecessors and disassembly of successors, the BI value is equal to Min(BR_{pred})−Max(BR_{succ}), wherein to Min(BR_{pred}) is the BR of the predecessors with the lowest value and Max(BR_{succ}) is the BR of the successors with the highest value. The combination above can be mixed. When the work zone 305 is at beginning or end point of the flow diagram 300, there is no predecessor or successor, respectively. Therefore, in this case, one of the BR_{pred} or BR_{succ}, respectively, is missing from the BI formula described above. The BR_{pred} of the work zone 305 at the beginning of the flow diagram 300 is calculated using the following formula BR_{pred}=1−BR_{succ}. To calculate the BR_{succ} of the work zone 305 at the end of the system, the following formula may be used BR_{succ}=1−BR_{pred}. The method 300 then proceeds to block 216.

At block 216, the controller 106 makes a list of the BI values from highest to lowest. The highest BI value is the top bottleneck. Then, the method 200 proceeds to block 218. At block 218, one or more action is taken to address the top bottleneck work time/variance, thereby improving the throughput of the manufacturing system 100. In other words, the controller 106 controls the manufacturing system 100 taking into account the top bottleneck work zone to maximize throughput of the manufacturing system. For example, the controller 106 may command one or more one or more conveyor belts 102 to increase or decrease their speed. All the formulas and actions of the method 200 mentioned assist the control system 105 in efficiently and effectively determining the top bottleneck work zone, thereby improving the functioning of the manufacturing system 100.

As used herein, a system, apparatus, structure, article, element, component, or hardware “configured to” perform a specified function is indeed capable of performing the specified function without alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Any feature of any embodiment may be used in combination with or substituted for any other feature or element in any other embodiment unless specifically restricted. Accordingly, the disclosure and the figures are to be regarded as illustrative rather than restrictive.

What is claimed is:

1. A method for identifying bottlenecks in a manufacturing system, comprising
creating, by a controller, a flow diagram showing how parts travel through the manufacturing system, wherein the manufacturing system comprises stations and buffers;
identifying, by the controller, work zones in the flow diagram that will be analyzed;
identifying, by the controller, predecessors and successors for each of the work zones in the flow diagram, wherein each of the predecessors and the successors is at least one of the stations or the buffers of the manufacturing system;
receiving, by the controller, a buffer use and station block/starve data of the manufacturing system;
gathering, by the controller, the buffer use and station block/starve data for the predecessors and the successors previously identified by the controller;
calculating, by the controller, a block ratio (BR) of the predecessors and the successors previously identified by the controller;
calculating, by the controller, bottleneck indicator (BI) values for the work zones using the BR of the predecessors and the successors;
making a list, by the controller, of the BI values from the highest to the lowest to identify a top bottleneck work zone of the work zones, wherein the top bottleneck work zone has a highest value of the BI values; and
controlling the manufacturing system taking into account the top bottleneck work zone to maximize throughput of the manufacturing system.

2. The method of claim 1, wherein the work zones include an intermediate work zone, the predecessor includes a single predecessor of the intermediate work zone, the successors include a single successors of the intermediate work zone such that the intermediate work zone has the single predecessor immediately preceding the intermediate work zone and the single successor immediately succeeding the intermediate work zone, wherein calculating, by the controller, the BI values for the work zones using the BR of the predecessors and the successors includes calculating the BI value of the intermediate work zone using a following equation:
BI=BR_{pred}−BR_{succ}
where:
BI is the BI value of the intermediate work zone;
BR_{pred} is the BR of the single predecessor of the intermediate work zone; and
BR_{succ} is the BR of the single successor of the intermediate work zone.

3. The method of claim 1, wherein the work zones include an assembly work zone, the predecessors include predecessors immediately preceding the assembly work zone, the successors include a single successor immediately succeeding the assembly work zone such that the assembly work zone has the predecessors and the single successor.

4. The method of claim 3, wherein calculating, by the controller, the BI values for the work zones using the BR of the predecessors and the successors includes calculating the BI value of the assembly work zone using a following equation:
BI=Min(BR_{pred})−BR_{succ};
where:
BI is the BI value of the assembly work zone;
Min(BR_{pred}) is the BR of one of the plurality of predecessors with a lowest value; and
BR_{succ} is the BR of the single successor of the assembly work zone.

5. The method of claim 1, wherein the work zones include a disassembly work zone, the predecessors include a single predecessor immediately preceding the disassembly work zone, the successors include a plurality of successors immediately succeeding the disassembly work zone such that disassembly work zone has the single predecessor and a plurality of successors.

6. The method of claim 5, wherein calculating, by the controller, the BI values for the work zones using the BR of the predecessors and the successors includes calculating the BI value of the disassembly work zone using a following equation:
BI=BR_{pred}−Max(BR_{succ});
where:
BI is the BI value of the disassembly work zone;
BR_{pred} is the BR of the single predecessor; and
Max(BR_{succ}) is the BR of one of the plurality of predecessors with a highest value.

7. The method of claim 1, wherein the work zones include a merge work zone, and calculating, by the controller, the BI values for the merge work zone using the BR of the predecessors and the successors includes calculating the BI value of the merge work zone using a following equation:
BI=PartCntWtdAvg(BR_{pred})−BR_{succ};
where:
BI is the BI value of the merge work zone;
PartCntWtdAvg(BR_{pred}) is a part count weighted average of the predecessors immediately preceding the merge work zone; and
BR_{succ} is the BR of the single successor of the work zone.

8. The method of claim 7, wherein the work zones include a split work zone, and calculating, by the controller, the BI values for the split work zone using the BR of the predecessors and the successors includes calculating the BI value of the split work zone using a following equation:
BI=BR_{pred}−PartCntWtdAvg(BR_{succ});
where:
BI is the BI value of the split work zone;
BR_{pred} is the BR of the single predecessor of the workzone; and
PartCntWtdAvg(BR_{succ}) is a part count weighted average of the successors immediately succeeding the split work zone.

9. The method of claim 1, wherein calculating, by the controller, the BR of the predecessors and the successors previously identified by the controller includes calculating the BR of the buffers using a following equation:
BR=(BufferFullRatio\hat{ }(Exp Factor)×0.5)−(1−BufferFullRatio)\hat{ }(Exp Factor)×0.5);
where:
BR is the block ratio of the buffers;
BufferFullRatio is a buffer full ratio; and
Exp Factor is an exponential factor;
wherein a buffer full ratio is calculated using a following equation:
BufferFullRatio=(AveragePartCount−Minimum Threshold)/(Maximum Threshold−Minimum Threshold);
where:
AveragePartCount is an average number of parts observed in the buffer for the time of observation;
Minimum Threshold is a minimum threshold of jobs that the buffers must have to prevent a downstream system from starvation; and
Maximum Threshold is a maximum number of jobs that are able to be stored in the buffers before upstream blocking occurs.

10. The method of claim 9, wherein calculating the BR of the buffers includes calculating the exponential factor using a following formula:
Exp Factor=(0.007×(Max Threshold−Min Threshold)\hat{ }(Flatness)−(0.017×(Max Threshold−Min Threshold)+3.3;
where:
Exp Factor is the exponential factor;
Min Threshold is a minimum threshold of jobs that the buffers have to prevent starvation downstream;
Max Threshold is a maximum number of jobs that the buffers is able to store blocking occurs upstream; and
Flatness is equal to 2.

11. The method of claim 10, wherein calculating, by the controller, the BR of the predecessors and the successors previously identified by the controller includes calculating the BR of the stations using a following equation:
BR=Block %/(Block %+Starve %),
where:
Block % is the percentage of time that the station 304 is blocked in the time of observation, and Starve % is the percentage of time the station 304 is starved in the time of observation. where:
BR is block ratio of the stations.

12. The method of claim 1, wherein calculating, by the controller, the BR of the predecessors and the successors previously identified by the controller includes calculating the BR of predecessor that is at the beginning of the flow diagram using a following equation:
BR_{pred}=0.5+0.5*(Block %),
where:
BR_{pred} is the BR of the predecessor that is at the beginning of the flow diagram; and
Block % is the percentage of time that the predecessor at the beginning of the flow is blocked in a predetermined time of observation.

13. The method of claim 1, wherein calculating, by the controller, the BR of the predecessors and the successors previously identified by the controller includes calculating the BR of a successor at an end of the flow diagram using a following equation:
BR_{succ}=0.5*(1−Starve %);
where:
BR_{succ} is the BR of the successor at the end of the flow; and
Starve % is the percentage of time the successor at the end of the flow is starved in a predetermined time of observation.

14. The method of claim 1, wherein a subject predecessor includes the plurality of successors immediately succeeding the predecessor, and calculating, by the controller, the BR of the predecessor previously identified by the controller includes calculating the BR of the subject predecessor using a following equation:
BR_{pred}=BR_{pred}−(BR_{pred}+1)*(Starve %−Starve %_{MinPredSucc})/(Starve %_{MaxPredSucc}−Starve %_{MinPredSucc});
where:
BR_{pred} is the block ratio of the subject predecessor;
BR_{MinPredSucc} is the minimum block ratio of the plurality of subject predecessor successors; and
BR_{MaxPredSucc} is the maximum block ratio of the plurality of subject predecessor successors.

15. The method of claim 1, wherein a subject successor includes the plurality of predecessors immediately preceding the successor, and calculating, by the controller, the BR of the successor previously identified by the controller includes calculating the BR of the subject successors using a following equation:
BR_{succ}=BR_{succ}−(1−BR_{succ})*(Block %−Block %_{MinSuccPred})/(Block %_{MaxSuccPred}−Block %_{MinSuccPred});
where:
BR_{succ} is the block ratio of subject successor;
BR_{MinSuccPred} is the minimum block ratio of the plurality of subject successor predecessors; and
BR_{MaxSuccPred} is the minimum block ratio of the plurality of subject successor predecessors.

16. The method of claim 1, wherein the predecessor includes a subject predecessor of a work zone with no predecessor itself because it is at the beginning of the flow diagram, and calculating, by the controller, the BR of that predecessor previously identified by the controller includes calculating the BR of the subject predecessor using the following formula:
BR_{pred}=1−BR_{succ};
where:
BR_{pred} is the BR of the subject predecessor; and
BR_{succ} is the BR of the successor.

17. The method of claim 1, wherein the successors include a subject successor with no successor itself, and calculating, by the controller, the BR of the successors previously identified by the controller includes calculating the BR of the subject successor using a following formula:
BR_{succ}=1−BR_{pred};
where:
BR_{succ} is the block ratio of the subject successor; and
BR_{pred} is the BR of the predecessor.

18. A control system, comprising:
a controller configured to be in communication with a manufacturing system, wherein the controller is programmed to:
create a flow diagram showing how parts travel through the manufacturing system, wherein the manufacturing system comprises stations and buffers;
identify work zones in the flow diagram that will be analyzed;
identify predecessors and successors for each of the work zones in the flow diagram, wherein each of the predecessors and the successors is at least one of the stations or the buffers of the manufacturing system;
receive buffer use and station block/starve data of the manufacturing system;
gather the buffer use and station block/starve data for the predecessors and the successors previously identified by the controller;
calculate a block ratio (BR) of the predecessors and the successors previously identified by the controller;
calculate bottleneck indicator (BI) values for the work zones using the BR of the predecessors and the successors;
make a list of the BI values from the highest to the lowest to identify a top bottleneck work zone of the work zones, wherein the bottleneck work zone has a highest value of the BI values; and
control the manufacturing system taking into account the top bottleneck work zone to maximize throughput of the manufacturing system.

19. The control system of claim 18, wherein the work zones include an intermediate work zone, the predecessor includes a single predecessor of the intermediate work zone, the successors include a single successors of the intermediate work zone such that the intermediate work zone has the single predecessor immediately preceding the intermediate work zone and the single successor immediately succeeding the intermediate work zone, wherein the controller is programmed to calculate the BI values for the work zones using a following equation:
BI=BR_{pred}−BR_{succ}
where:
BI is the BI value of the intermediate work zone;
BR_{pred} is the BR of the single predecessor of the intermediate work zone; and
BR_{succ} is the BR of the single successor of the intermediate work zone.

20. The control system of claim 18, wherein the work zones include an assembly work zone, the successors include predecessors immediately preceding the assembly work zone, the successors include a single successor immediately succeeding the assembly work zone such that the assembly work zone has the predecessors and the single predecessor.
